(19) United States
(12) Patent Application Publication
(10) Pub. No.: US 2026/0288256 A1
(43) Pub. Date: Sep. 24, 2026

(54) TILT NAVIGATION FOR STACKED USER INTERFACE LAYERS

(71) Applicant: MICROSOFT TECHNOLOGY LICENSING, LLC, Redmond, WA (US)

(72) Inventor: Matthew Joseph SANTONE, Austin, TX (US)

(21) Appl. No.: 19/086,413

(22) Filed: Mar. 21, 2025

(51) Int. Cl. G06F 3/0346

(52) U.S. Cl. CPC G06F 3/0346

(57) ABSTRACT

The techniques presented herein provide a system for tilt navigation of stacked user interface layers on a mobile device such as a smartphone or a tablet. Modern mobile devices are versatile computing devices that are integral to the daily lives of many users. Consequently, modern software applications take advantage of ever-increasing computational power and efficiency to provide large, diverse sets of features. Unfortunately, expanding functionality often leads to a user interface that is unwieldy, inefficient, and/or simply unpleasant to use. In contrast, the present system organizes user interfaces into layers that are rendered on the mobile device as a stack (e.g., a stack of cards). In this way, the various user interfaces are presented to the user as intuitive extensions of one another. That is, tilt navigation provides the sensation of naturally adjusting one's line of sight rather than the burden of juggling multiple screens.

### BACKGROUND

As mobile devices such as smartphones and tablets become increasingly capable and versatile, more and more users rely on mobile devices to perform essential tasks including socializing, shopping, banking, and even running businesses. Consequently, the software applications that are available for mobile devices have likewise ballooned in functionality, leveraging new levels of computational power and efficiency to provide ever-expanding suites of features. For example, a modern social media application oftentimes includes functionality for viewing and interacting with content (e.g., text, photos), direct messaging between users, producing and editing content, collecting analytics, managing advertising, and even artificial intelligence models. Accordingly, each of these different functions is organized in its own user interface. That is, the application includes one user interface for scrolling through content, another user interface for search, still another user interface for direct messages, and so forth.

Unfortunately, this vast array of features can result in applications that, while powerful and functional, provide a user experience that feels bloated and cumbersome. For example, returning to the aforementioned social media application, a user that wishes to share a picture with a friend will need to navigate through several user interfaces to capture, edit, post, and share the picture with the friend, respectively. While a cumbersome user interface may be a relatively minor concern in a social media application, these inefficiencies can have more severe effects in productivity and/or professional collaboration applications that users rely on to produce work and/or conduct business.

It is with respect to these and other considerations that the disclosure made herein is presented.

### SUMMARY

The techniques presented herein provide a system for tilt navigation of stacked user interface layers on a mobile device such as a smartphone or a tablet. As mentioned above, modern mobile devices are versatile computing devices that are integral to the daily lives of many users. Likewise, modern software applications take advantage of ever-increasing computational power and efficiency to provide large, diverse sets of features. Unfortunately, expanding functionality often leads to a user interface that is unwieldy, inefficient, and/or simply unpleasant to use. For instance, a social media application may have a first user interface for viewing content (e.g., text, images), a different user interface for direct messaging, still another user interface for search, and so forth. Consequently, the many taps and/or swipes required to navigate the different user interfaces in the social media application can be a confusing and/or frustrating user experience.

In contrast, the present system organizes user interfaces into layers that are rendered on the mobile device as a stack (e.g., a stack of cards). In some examples, the stack of user interface layers all belong to the same software application. For instance, in a social media application, a first user interface layer is directed to viewing content while a second user interface layer is directed to direct messaging. Conversely, a stack of user interface layers includes individual user interface layers that belong to different applications. For instance, a user that finds themselves frequently switching between an email application and a personal planner application may set up a multitasking configuration with a first user interface layer for the email application and a second user interface layer for the personal planner application.

In various examples, the stack of user interface layers is enabled via an activation signal that causes the system to configure a default device posture based on an initial tilt angle of the mobile device that is retrieved from an onboard hardware sensor (e.g., an accelerometer, a gyroscope). In a specific example, the activation signal is the user opening a software application that utilizes stacked user interface layers. In response, the software application reads the current tilt angle of the mobile device from the hardware sensor and sets the current tilt angle as the default device posture. That is, the default device posture is a baseline position from which the user tilts their mobile device. In addition, the activation signal causes the software application to render a first user interface layer on the display of the mobile device and enable an interactable element of the first user interface layer (e.g., tapping, scrolling, typing). In some configurations, the first user interface layer is a default user interface layer that includes a primary functionality of the software application where the second user interface layer is directed to a secondary functionality. For instance, the first user interface layer for an email application can be the inbox while the second user interface layer is the calendar.

The user can then tilt the mobile device to provide a tilt input that is received by the onboard hardware sensor. Generally described, tilt input modifies the tilt angle of the mobile device from the initial tilt angle that was previously captured by the hardware sensor. Consequently, the difference between the modified tilt angle and the initial tilt angle represents a deviation from the default device posture. For example, if the initial tilt angle was fifteen degrees (15°) and the modified tilt angle is twenty-five degrees (25°), the deviation is ten degrees (10°).

The system can be configured with a threshold deviation to prevent accidental switching between user interface layers. In various examples, the threshold deviation is a significant change in tilt angle (e.g., thirty degrees, 30°) such that the user interface layers change only when the user is clearly intending to switch between user interface layers. Consequently, an insignificant tilt input does not cause the software application to transition to another user interface layer. Nonetheless, the system can respond to small changes in tilt angle by altering the rendering of the first user interface layer with transparency to indicate the presence of a second user interface layer beneath the first user interface layer. While the second user interface layer may be visible, the interactable elements of the second user interface layer are disabled to prevent unintended inputs.

The user can then continue to tilt the mobile device to provide another tilt input that further modifies the tilt angle of the mobile device. For example, while the tilt angle of the first tilt input was twenty-five degrees (25°) the tilt angle of the second tilt input may be fifty degrees (50°). As a result, the difference between the second tilt angle and the initial tilt angle of fifteen degrees (15°) is thirty-five degrees (35°) which satisfies the threshold deviation from the default device posture. In response, the system transitions from the first user interface layer to second user interface layer and activates the interactable elements of the second user interface layer. In a specific example, the second user interface layer provides direct messaging functionality. Accordingly, the interactable elements include scrolling through and/or tapping on chat messages, typing on a keyboard, and so forth.

In contrast to conventional user interface systems that rely on a labyrinth of nested lists and menus, the present system enables a user to transition between user interface layers smoothly and intuitively. For example, a user that is collaborating with coworkers on a document can easily switch between a main work area containing the document and a chat window for communicating with the coworkers without tapping buttons or navigating menus. In this way, the various user interfaces are presented to the user as intuitive extensions of one another. That is, tilt navigation provides the sensation of naturally adjusting one's line of sight rather than the burden of juggling multiple screens.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for tilt navigation for a stack of user interface layers in a mobile device.

FIG. 2A illustrates an example user interface layer stack and a side perspective of a mobile device utilizing tilt navigation.

FIG. 2B illustrates an example tilt input that does not satisfy a threshold deviation to switch user interface layers.

FIG. 2C illustrates an example tilt input that satisfies a threshold deviation to switch user interface layers.

FIG. 3 illustrates an example of a mobile device utilizing tilt navigation via horizontal tilt inputs.

FIG. 4 is a flow diagram showing aspects of a process for tilt navigation in a stack of user interface layers on a mobile device.

FIG. 5 is a computer architecture diagram illustrating an illustrative computer hardware and software architecture for a computing system capable of implementing aspects of the techniques and technologies presented herein.

### DETAILED DESCRIPTION

The techniques presented herein provide a system for tilt navigation of stacked user interface layers on a mobile device such as a smartphone or a tablet. As mentioned above, modern mobile devices are versatile computing devices that are integral to the daily lives of many users. Likewise, modern software applications take advantage of ever-increasing computational power and efficiency to provide large, diverse sets of features. Unfortunately, expanding functionality often leads to a user interface that is unwieldy, inefficient, and/or simply unpleasant to use. In contrast, the present system organizes user interfaces into layers that are rendered on the mobile device as a stack (e.g., a stack of cards). In this way, the various user interfaces are presented to the user as intuitive extensions of one another. That is, tilt navigation provides the sensation of naturally adjusting one's line of sight rather than the burden of juggling multiple screens. Consequently, tilt navigation of user interface layers provides an intuitive user experience that reduces friction and improves efficiency.

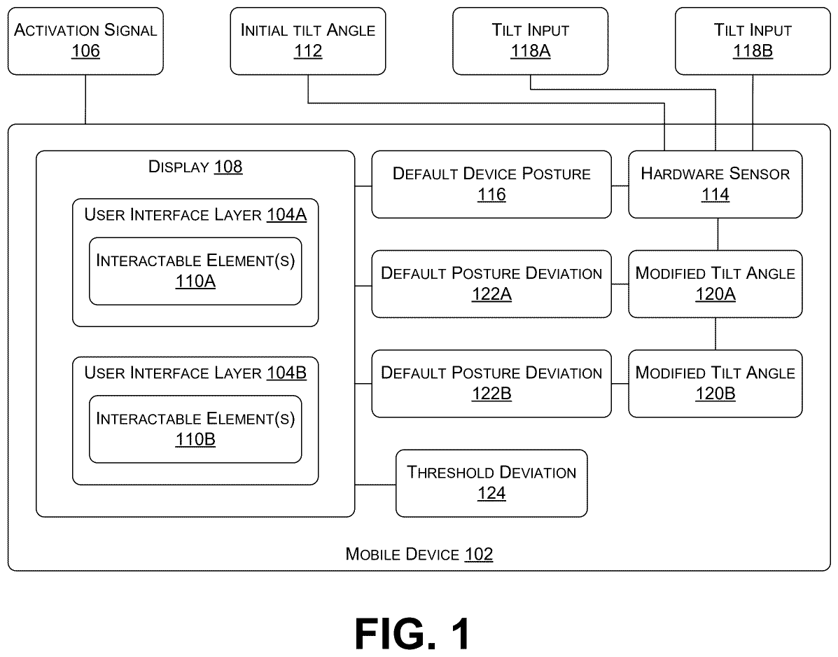

Various examples, scenarios, and aspects related to the techniques are described below with respect to FIGS. 1-5.

FIG. 1 illustrates a system comprising a mobile device 102 that is configured to utilize tilt navigation for a user interface. As shown, the mobile device 102 initializes a stack of user interface layers 104A and 104B in response to an activation signal 106 and renders the first user interface layer 104A on a display 108 (e.g., a touchscreen). In a specific example, the activation signal 106 is automatically generated when a user opens a software application that is configured, e.g., via a defined setting (e.g., user-defined, application-defined), to utilize tilt navigation via either the software application itself or the operating system of the mobile device 102. In the present example, the user interface layers 104A and 104B belong to the same software application. In an alternative example, the activation signal 106 is manually generated by the user when setting up a multitasking configuration for a current session and/or experience with one or more software applications. As such, the user interface layers 104A and 104B may belong to the same software application or different software applications (e.g., an email application, a personal planner application).

Each of the user interface layers 104A and 104B include interactable elements 110A and 110B, respectively. Within the context of the present disclosure, an interactable element 110 is any user interface element that is capable of receiving a user input (e.g., a tap, a click, a swipe). Examples of interactable elements 110 include buttons, scroll bars, keyboards, selectable text and/or images, and the like. In other examples, the interactable element 110 may be an underlying operating system interaction that is not associated with a graphical rendering (e.g., scrolling a document). Accordingly, when the mobile device 102 renders the first user interface layer 104A, the interactable element 110A is enabled. That is, the interactable element 110A can receive user inputs. Conversely, the interactable element 110B of the second user interface layer 104B, which is not currently rendered, is disabled (e.g., locked) such that the interactable element 110B cannot receive user inputs.

In addition to initializing the stack of user interface layers 104A and 104B, the mobile device 102 retrieves an initial tilt angle 112 via an onboard hardware sensor 114 such as an accelerometer and/or a gyroscope. In a specific example, the hardware sensor 114 is an accelerometer in which the initial tilt angle 112 is retrieved by measuring the vector of gravity and its projection on the axes of the accelerometer. Consequently, changes in the tilt angle 112 can be detected by the accelerometer by measuring changes in the projection of the gravity vector.

The initial tilt angle 112 is then used by the mobile device 102 to configure a default device posture 116 which serves as a baseline for enabling tilt navigation. That is, rather than use a pure tilt angle measurement to navigate between the user interface layers 104A and 104B, the mobile device 102 measure deviations from the default device posture 116. For instance, a user may pick up their smartphone off of a tabletop and open an application that utilizes tilt navigation. Accordingly, the mobile device 102 establishes the default device posture 116 based on the angle at which the user was holding the smartphone when the user opens the app (i.e., the initial tilt angle 112).

Subsequently, the user provides a first tilt input 118A that causes the hardware sensor 114 to measure a first modified tilt angle 120A. For example, assuming an initial tilt angle of fifteen degrees (15°), the modified tilt angle 120A may be thirty degrees (30°). As mentioned, the mobile device 102 processes the modified tilt angle 120A in relation to the initial tilt angle 112 of the default device posture 116. Therefore, the difference between the modified tilt angle 120A and the initial tilt angle 112 represents a first default posture deviation 122A. That is, while the modified tilt angle 120A is thirty degrees (30°), the deviation from the initial tilt angle is only fifteen degrees (15°).

In addition, the mobile device 102 can determine that the first default posture deviation 122A does not satisfy a threshold deviation 124 for transitioning between the first user interface layer 104A and the second user interface layer 104B. Generally described, the threshold deviation 124 is a threshold difference between the modified tilt angle 120A and the initial tilt angle 112 that controls whether the display 108 transitions from the first user interface layer 104A to the second user interface layer 104B. For example, the threshold deviation 124 can be configured to thirty degrees (30°) meaning that the user must tilt the mobile device 102 thirty degrees (30°) from the initial tilt angle 112 to switch user between interface layers 104A and 104B. In this way, the threshold deviation 124 can be configured such that the user does not accidentally switch layers thereby preventing frustration and/or confusion. Nonetheless, the mobile device 102 can respond to changes in tilt angle 120A by altering the rendering of the first user interface layer 104A with transparency to indicate the presence of the second user interface layer 104B beneath the first user interface layer 104A in the stack. While the second user interface layer 104B may be visible, e.g., to a user, the interactable elements 110B of the second user interface layer 104B are disabled (e.g., locked) to prevent unintended user inputs.

Accordingly, the user can continue tilting the device to provide a second tilt input 118B that is read by the hardware sensor 114 as a second modified tilt angle 120B. Similar to the first tilt input 118A, the difference between the second modified tilt angle 120B and the initial tilt angle 112 represents a second deviation 122B from the default device posture 116. In the present example, consider a second tilt angle 120B of fifty degrees (50°) resulting in a second default posture deviation 122B of thirty-five degrees (35°). Consequently, it can be said that the second default posture deviation 122B satisfies the threshold deviation 124. In response, the mobile device 102 renders the second user interface layer 104B and enables (e.g., unlocks) the interactable elements 110B. From the perspective of the user, rendering the display 108 in this manner provides the sensation of shifting the mobile device 102 through the stack of user interface layers 104A and 104B.

It should be understood that while the tilt inputs 118A and 118B are described as discrete inputs, in practice, the hardware sensor 114 may continuously measure the tilt angle of the mobile device 102. For instance, the hardware sensor 114 can be configured with a specific polling rate defining the frequency at which the hardware sensor 114 measures the tilt angle (e.g., 100 hz or one hundred times per second). In this way, the tilt navigation provides a smooth and seamless user experience.

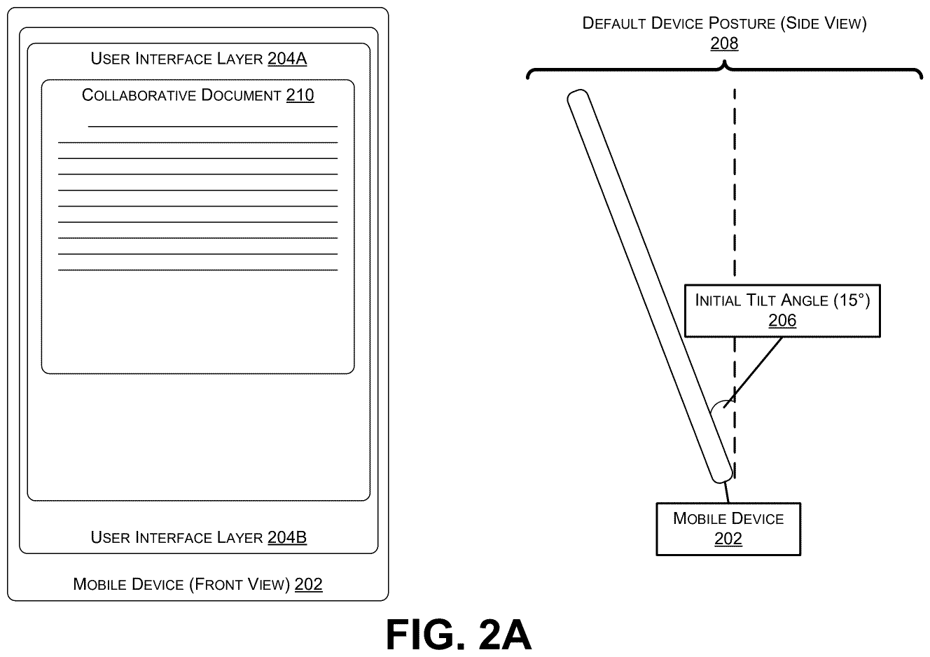

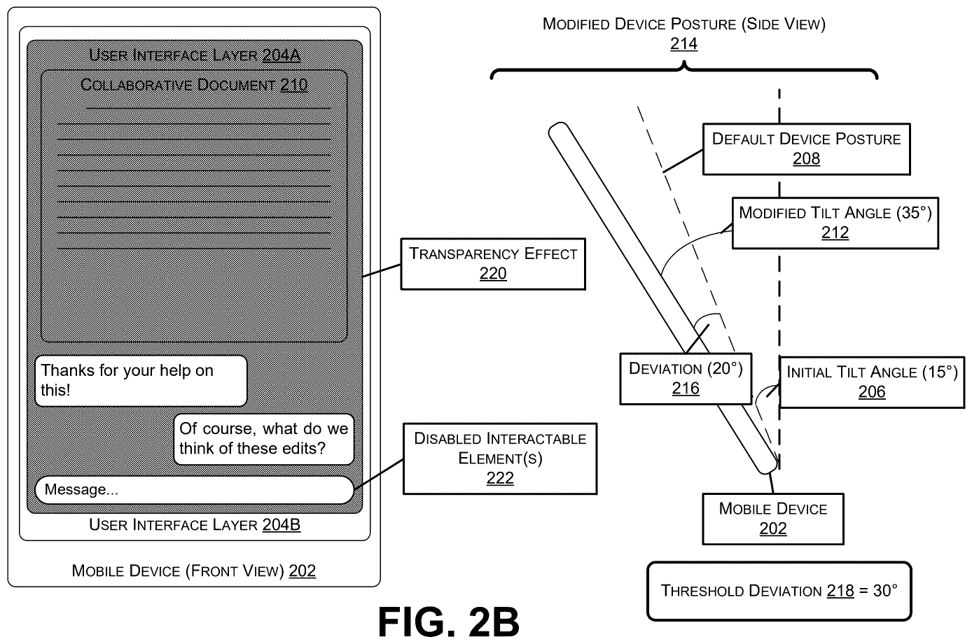

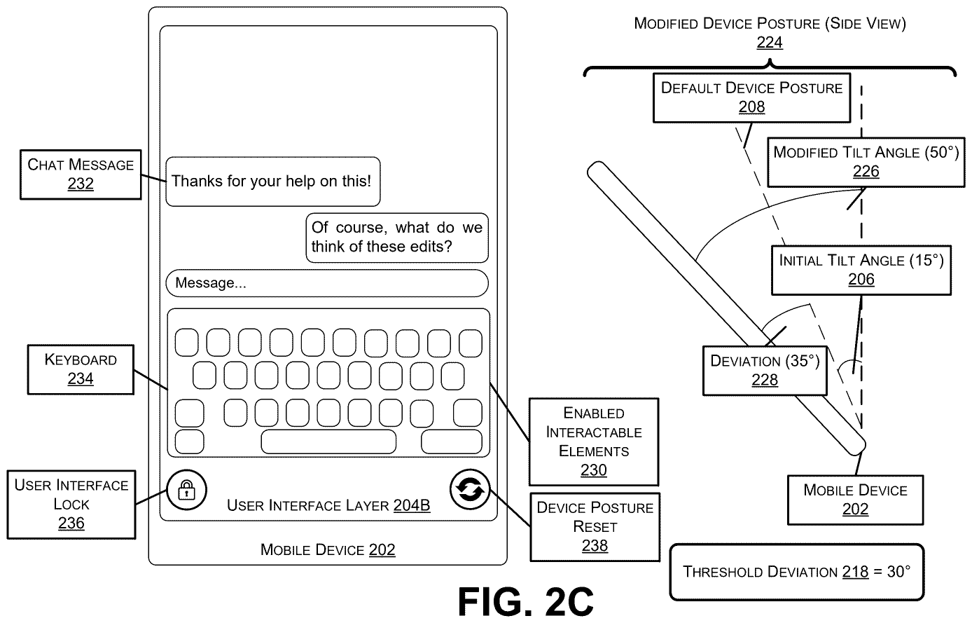

Turning now to FIG. 2A, aspects of an example user interface interaction are shown and described. Similar to the examples discussed above, a software application on a mobile device 202 is configured with tilt navigation and a user interface comprising a stack of user interface layers 204A and 204B. In the present example, the user has just picked up the mobile device 202 and opened the software application which serves as an activation signal that causes the mobile device 202 to initialize the user interface. In response, the mobile device 202 retrieves an initial tilt angle 206 via an onboard hardware sensor (e.g., an accelerometer, a gyroscope). As shown in FIG. 2A, the initial tilt angle 206 is measured with respect to a vertical axis (e.g., the direction of gravity). However, it should be understood that the initial tilt angle 206 can be measured in any suitable manner (e.g., with respect to a horizontal axis).

Accordingly, the mobile device 202 utilizes the initial tilt angle 206 to configure a default device posture 208. As described above, the default device posture 208 serves as a baseline from which the mobile device 202 processes subsequent tilt inputs. As shown, the initial tilt angle 206 is fifteen degrees (15°). Moreover, the mobile device 202 renders the first user interface layer 204A. In the present example, the software application utilizing the stack of user interface layers 204 is a productivity tool that enables users to co-work on documents simultaneously. As such, the primary function of the software application is editing a collaborative document 210. Consequently, when initializing the user interface, the first user interface layer 204A that is rendered includes the collaborative document 210. In addition, the first user interface layer 204A is rendered such that it appears above the second user interface layer 204B (e.g., in a stacked manner).

Turning now to FIG. 2B, the user begins to tilt the mobile device 202 to provide a tilt input comprising a modified tilt angle 212 that is read by the mobile device 202 via an onboard hardware sensor (e.g., an accelerometer, a gyroscope). As shown, the modified tilt angle 212 results in a modified device posture 214 in which the difference between the modified tilt angle 212 and the initial tilt angle 206 is processed as a deviation 216 from the default device posture 208. That is, while the modified tilt angle 212 may be thirty-five degrees (35°), for an initial tilt angle 206 of fifteen degrees (15°), the deviation 216 is twenty degrees (20°).

In addition, the mobile device 202 is configured with a threshold deviation 218 that controls whether the mobile device switches from the first user interface layer 204A to the second user interface layer 204B. As shown, the threshold deviation 218 is thirty degrees (30°). Consequently, the threshold deviation 218 requires a significant change in the modified tilt angle 212 to switch between the user interface layers 204. In this way, the threshold deviation 218 prevents the user from accidentally switching user interface layers 204 thereby reducing confusion and/or frustration.

In the present example, the deviation 216 of the modified device posture 214 does not satisfy the threshold deviation 218 (e.g., 20° is not greater than or equal to 30°). In response, the mobile device 202 does not transition the user interface from the first user interface layer 204A to the second user interface 204B. However, the mobile device 202 can nonetheless respond to the modified device posture 214 by modifying the rendering of the first user interface layer 204A with a transparency effect 220 based on the modified tilt angle 212 as shown in FIG. 2B by the shading of the first user interface element 204A and the collaborative document 210. In various embodiments, the intensity of the transparency effect 220 varies continuously in proportion to the modified tilt angle 212. Consequently, the second user interface layer 204B, which includes functionality for sending chat messages, becomes partially visible beneath the first user interface layer 204A. However, while the second user interface layer 204B is partially visible, the present rendering of the second user interface layer 204B includes disabled interactable elements 222 (e.g., chat messages, an input text box). Stated another way, the interactable elements 222 of the second user interface layer 204B are locked to prevent erroneous and/or unexpected inputs when the second user interface layer 204B is not the active user interface layer (e.g., on top of the stack). For instance, when the interactable elements 222 are locked, the user cannot tap, type, scroll or otherwise interact with the second user interface layer 204B.

Proceeding to FIG. 2C, the user continues tilting the mobile device 202 which results in another modified device posture 224 comprising a modified tilt angle 226 of fifty degrees (50°). Similar to the examples described above, the modified device posture 224 is characterized by the deviation 228 from the default device posture 208 which is defined as the difference between the modified tilt angle 226 and the initial tilt angle 206 of fifteen degrees (15°). In the present example, the deviation 228 is thirty-five degrees (35°) which satisfies the threshold deviation 218 of thirty degrees (30°). In response, the mobile device 202 transitions from the first user interface layer 204A to the second user interface layer 204B. In one example, the mobile device 202 fully renders the second user interface layer 204B which now includes various enabled interactable elements 230. That is, the first user interface layer 204A is removed from view (e.g., fully transparent) and the interactable elements therein (e.g., the collaborative document 210) are disabled (e.g., locked). In an alternative example, the mobile device 202 reconfigures the stack of user interface layers 204 such that the first user interface layer 204A is visually beneath and/or behind the second user interface layer 204B.

Examples of the enabled interactable elements 230 of the second user interface layer 204B include individual chat messages 232, a keyboard 234, and the ability to swipe and scroll through the user interface. Furthermore, the enabled interactable elements 230 include a user interface lock 236 and a device posture reset 238. In various examples, the user interface lock 236 can be enabled by the user (e.g., via a tap) to disable tilt navigation. In a specific example, if the user wishes to lie down in bed without changing user interface layers 204, the user can enable the user interface lock 236 such that the mobile device will ignore changes in the tilt angle.

In another example, the device posture reset 238 causes the mobile device 202 to reconfigure the default device posture 208 based on an updated tilt angle (e.g., changing the initial tilt angle 206 to a current tilt angle such as the modified tilt angle 226). That is, the device posture reset 238 resets the baseline from which tilt inputs are processed. Consequently, the mobile device 202 may return the user interface to the first user interface layer in response to the user activating the device posture reset 238. Conversely, the mobile device 202 may simply modify the default device posture 208 without changing the user interface layer 204. In this way, the user can customize tilt navigation to their preference thereby ensuring a comfortable and intuitive user experience.

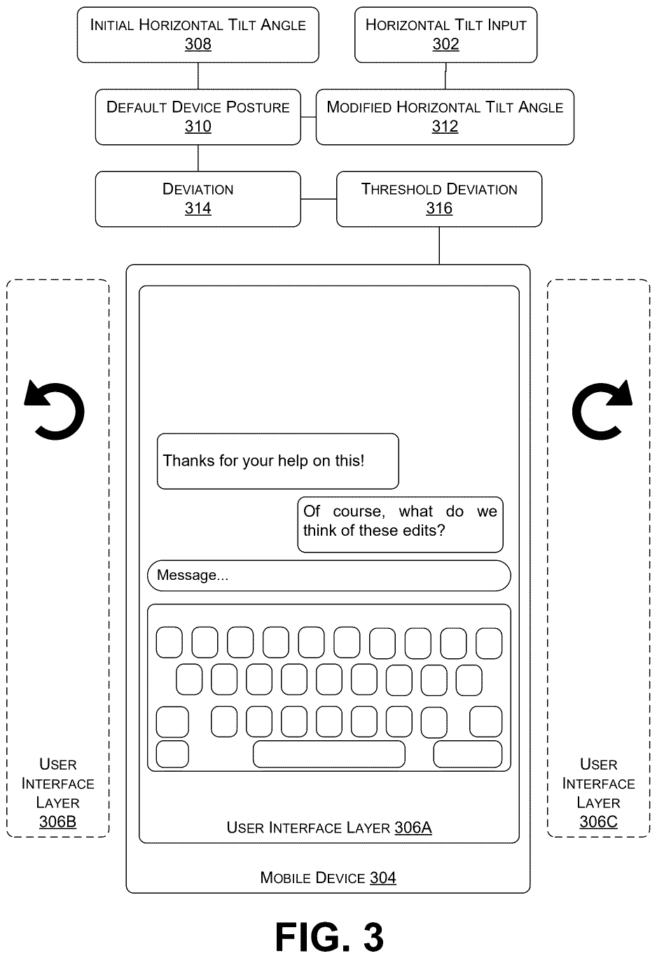

Turning now to FIG. 3, aspects of tilt navigation using a horizontal tilt input 302 are shown and described. While the examples illustrated and discussed above with respect to FIGS. 2A-2C are directed to a vertical tilt input (e.g., tilting the mobile device toward and/or away from oneself), the example of FIG. 3 is directed to a horizontal tilt input 302 in which the user tilts a mobile device 304 from side to side. It should be understood that while the example of FIG. 3 is shown as an independent operation, horizontal tilt navigation can be utilized in conjunction with or instead of the vertical tilt navigation features discussed above.

As shown in the present example, the mobile device 304 displays a user interface comprising a first user interface layer 306A which includes text chat functionality. In addition, similar to the examples discussed above, the mobile device 304 retrieves an initial horizontal tilt angle 308 via an onboard hardware sensor (e.g., an accelerometer, a gyroscope). The initial horizontal tilt angle 308 is accordingly used to configure a default device posture 310. Moreover, the horizontal tilt input 302 comprises a modified horizontal tilt angle 312. Consequently, the difference between the initial horizontal tilt angle 308 and the modified horizontal tilt angle 312 defines a deviation 314 from the default device posture 310. Accordingly, the mobile device compares the deviation 314 against a threshold deviation 316.

In situations where the horizontal tilt input 302 is utilized in conjunction with vertical tilt navigation (e.g., FIGS. 2A-2C), the threshold deviation 316 for the horizontal tilt input can be configured independently from the threshold deviation for vertical tilt inputs (e.g., a second threshold deviation). Likewise, the deviation 314 can be separate and different from the deviation described above with respect to FIGS. 2A-2C. That is, where the user may provide a first and/or a second deviation via vertical tilt inputs, the user may subsequently provide a third deviation 314 via the horizontal tilt input 302.

Similar to the above examples, the threshold deviation 316 controls whether the mobile device 304 transitions from the user interface 306A to either of other user interface layers 306B or 306C. For the sake of discussion, consider a horizontal tilt input 302 that results in a deviation 314 that satisfies the threshold deviation 316. Accordingly, the mobile device 304 can also account for the directionality of the horizontal tilt input 302 (e.g., a tilt to the left or a tilt to the right). For instance, horizontal tilt input 302 to the left causes the mobile device 304 to transition to the user interface layer 306B. Conversely, if the horizontal tilt input 302 is to the right, the mobile device 304 transitions to the user interface layer 306C.

In various examples, the user interface layers 306B and 306C belong to the same software application as the first user interface layer 306A. For example, where the first user interface layer 306A is directed to sending and receiving chat messages, the second user interface layer 306B may be directed to editing a collaborative document while the third user interface layer 306C can be directed to software application settings. In an alternative example, the second user interface layer 306B and the third user interface layer 306C belong to respectively different software applications from the first user interface layer 306A. For instance, the user may manually configure a multitasking setup utilizing the horizontal tilt input 302 to switch between software applications. In a specific example, the user can utilize the horizontal tilt input 302 to switch between messaging application in the first user interface layer 306A, an email application in the second user interface layer 306B, and a personal planner application in the third user interface layer 306C.

In another example, consider a stack of five user interface layers. By utilizing vertical tilt navigation in conjunction with horizontal tilt navigation, as described herein, the user can quickly navigate a complex user interface by tilting the mobile device 304 forward, backward, left, and right. For instance, assuming a first user interface layer that is rendered by default, a backwards vertical tilt navigates to the second user interface layer, a forwards vertical tilt navigates to the third user interface layer, a leftward horizontal tilt navigates to the fourth user interface layer, and a rightward horizontal tilt navigates to the fifth user interface layer. In this way, the tilt navigation (e.g., vertical and/or horizontal tilt inputs) provides a more engaging user experience in relation to conventional tap and/or swipe navigation thereby improving the efficiency of the mobile device 304.

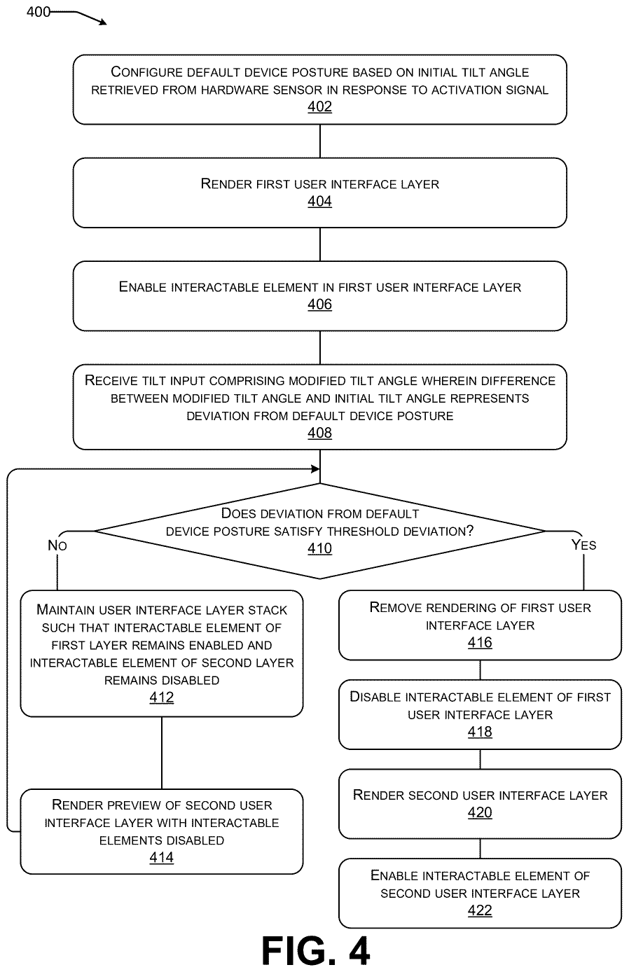

Turning now to FIG. 4, aspects of a process 400 for tilt navigation in a stack of user interface layers on a mobile device are shown and described. With respect to FIG. 4, the process 400 begins at operation 402 in which a mobile device configures a default device posture based on an initial tilt angle that is retrieved from an onboard hardware sensor (e.g., an accelerometer, a gyroscope). In various examples, the configuration is implemented in response to receiving an activation signal, which may be automatically generated when the user opens a tilt navigation user interface (e.g., a software application, an operating system).

Next, at operation 404, the mobile device renders a first user interface layer on a display of the mobile device. As described, the first user interface layer can be a default user interface layer that is directed to a primary functionality of a software application where the second user interface layer is directed to a secondary functionality. For instance, in a software application for editing a collaborative document, the first user interface layer can be the document editor while the second user interface layer is a text chat. However, the default user interface layer may also be customized by the user based on their preferences.

In addition, at operation 406, the mobile device enables an interactable element of the first user interface layer. Within the context of the present disclosure, an interactable element is any user interface element that can receive user inputs such as tapping, scrolling, pinching, typing, and the like. Examples of interactable elements include buttons, scroll bars, keyboards, selectable text and/or images, and the like.

Then, at operation 408, the mobile device receives, via the onboard hardware sensor, a tilt input comprising a modified tilt angle wherein the difference between the modified tilt angle and the initial tilt angle represents a deviation from the default device posture. As discussed above, the default device posture serves as a baseline from which the mobile device processes tilt inputs. That is, while a given tilt input may have a specific associated angle such as fifty degrees (50°) the change from initial tilt angle may be less (e.g., twenty degrees, 20°).

Subsequently, at operation 410, the mobile device determines whether the deviation caused by the tilt input satisfies a threshold deviation. In a first example, the deviation does not satisfy the threshold deviation. For instance, given an initial tilt angle of fifteen degrees (15°) and a modified tilt angle of twenty-five degrees (25°), the deviation is ten degrees (10°). However, the threshold deviation may be thirty degrees (30°) to prevent accidental transitions between user interface layers.

In response, the process 400 proceeds to operation 412 in which the mobile device does not transition between user interface layers. That is, the mobile device maintains the stack of user interface layers such that the interactable element of the first user interface layer remains enabled (e.g., unlocked) while the interactable element of the first user interface layer remains disabled (e.g., locked). However, to provide an engaging user experience, the mobile device may react to the modified tilt angle by adjusting the rendering of the user interface.

For instance, in operation 414, the mobile device renders a preview of the second user interface layer with its interactable elements disabled. In a specific example, this preview is achieved by applying a transparency effect to the first user interface layer to reveal the presence of the second user interface layer beneath. Moreover, the intensity of the transparency effect can vary with respect to the tilt angle of the mobile device as the user continues to tilt until the deviation ultimately satisfies the threshold deviation. Accordingly, the process 400 returns to operation 410. That is, the mobile device is configured to continuously monitor the tilt angle to detect deviations from the default device posture.

In the event the deviation from the default device posture satisfies the threshold deviation, the process 400 proceeds to operation 416 in which the mobile device begins transitioning from the first user interface layer to the second user interface layer by removing the rendering of the first user interface layer. In one example, this is achieved by rendering the first user interface layer as fully transparent. Then, at operation 418, the mobile device disables the interactable elements of the first user interface layer. In this way, the mobile device prevents accidental user inputs during and/or after the transition.

Next, at operation 420, the mobile device renders the second user interface layer. In this way, the mobile device provides the sensation that the user has moved the mobile device “through” the first user interface layer and into the second user interface layer below. Finally, at operation 422, the mobile device completes the transition by enabling the interactable element of the second user interface layer.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 400 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 400 may also be implemented in other ways. In addition, one or more of the operations of the process 400 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

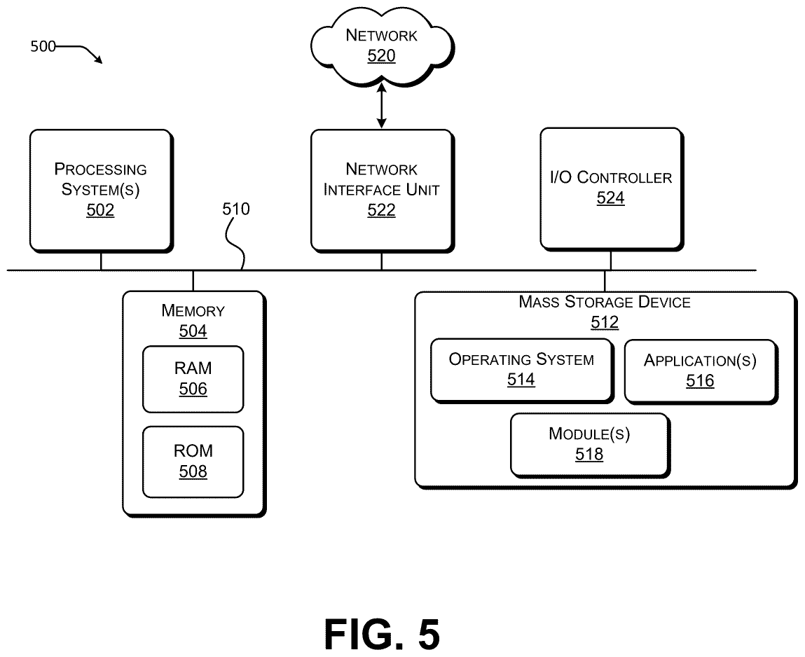

FIG. 5 shows additional details of an example computer architecture 500 for a device, capable of executing computer instructions (e.g., a module or a program component described herein). The computer architecture 500 illustrated in FIG. 5 includes processing system 502, a system memory 504, including a random-access memory 506 (RAM) and a read-only memory (ROM) 508, and a system bus 510 that couples the memory 504 to the processing system 502. The processing system 502 comprises processing unit(s). In various examples, the processing unit(s) of the processing system 502 are distributed. Stated another way, one processing unit of the processing system 502 may be located in a first location (e.g., a rack within a datacenter) while another processing unit of the processing system 502 is located in a second location separate from the first location. Moreover, the systems discussed herein can be provided as a distributed computing system such as a cloud service.

Processing unit(s), such as processing unit(s) of processing system 502, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518, and other data described herein.

The mass storage device 512 is connected to processing system 502 through a mass storage controller connected to the bus 510. The mass storage device 512 and its associated computer-readable media provide non-volatile storage for the computer architecture 500. Although the description of computer-readable media contained herein refers to a mass storage device, the computer-readable media can be any available computer-readable storage media or communication media that can be accessed by the computer architecture 500.

Computer-readable media includes computer-readable storage media and/or communication media. Computer-readable storage media includes one or more of a volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

The software components described herein may, when loaded into the processing system 502 and executed, transform the processing system 502 and the overall computer architecture 500 from a general-purpose computing system into a special-purpose computing system customized to facilitate the functionality presented herein. The processing system 502 may be constructed from any number of transistors or other discrete circuit elements, which may individually or collectively assume any number of states. More specifically, the processing system 502 may operate as a finite-state machine, in response to executable instructions contained within the software modules disclosed herein. These computer-executable instructions may transform the processing system 502 by specifying how the processing system 502 transition between states, thereby transforming the transistors or other discrete hardware elements constituting the processing system 502.

The disclosure presented herein also encompasses the subject matter set forth in the following clauses.

Example Clause A, a method for tilt navigation of a stack of at least two user interface layers in a mobile device, the method comprising: configuring a default device posture based on an initial tilt angle that is retrieved from a hardware sensor of the mobile device; rendering a first user interface layer on a display of the mobile device; and enabling an interactable element within the first user interface layer; receiving, by the hardware sensor, a first tilt input comprising a first modified tilt angle of the mobile device, wherein: a difference between the first modified tilt angle and the initial tilt angle represents a first deviation from the default device posture; and the first deviation from the default device posture does not satisfy a threshold deviation; in response the first deviation from the default device posture not satisfying the threshold deviation, rendering a preview of a second user interface layer, wherein an interactable element within the second user interface layer is disabled; receiving, by the hardware sensor, a second tilt input comprising a second modified tilt angle of the mobile device, wherein: a difference between the second modified tilt angle and the initial tilt angle represents a second deviation from the default device posture; and the second deviation from the default device posture satisfies the threshold deviation; in response to the second deviation from the default device posture satisfying the threshold deviation, transitioning from the first user interface layer to the second user interface layer by: removing the rendering of the first user interface layer; disabling the interactable element of the first user interface layer; rendering the second user interface layer; and enabling the interactable element within the second user interface layer.

Example Clause B, the method of Example Clause A, wherein the configuring is implemented in response to an activation signal.

Example Clause C, the method of Example Clause B, wherein the activation signal is a manual input or the activation signal is automatically generated by an operating system of the mobile device.

Example Clause D, the method of any one of Example Clause A through C, wherein: the first user interface layer and the second user interface layer belong to a same software application; the first user interface layer includes a primary functionality of the software application; the second user interface layer includes a secondary functionality of the software application; and the first user interface layer is configured as a default user interface layer.

Example Clause E, the method of any one of Example Clause A through D, wherein: the first user interface layer and the second user interface layer are rendered as a stack; and a transparency of the first user interface layer and the second user interface layer is configured based on a deviation from the default device posture.

Example Clause F, the method of any one of Example Clause A through E, wherein: the first tilt input and the second tilt input are vertical tilt inputs; and the first modified tilt angle and the second modified tilt angle are received by the hardware sensor with respect to a vertical axis.

Example Clause G, the method of any one of Example Clause A through E, wherein: the first tilt input and the second tilt input are horizontal tilt inputs; and the first modified tilt angle and the second modified tilt angle are received by the hardware sensor with respect to a horizontal axis.

Example Clause H, the method of any one of Example Clause A through G, further comprising reconfiguring the default device posture based on an updated tilt angle in response to receiving a device posture reset input.

Example Clause I, a system for tilt navigation of a stack of at least two user interface layers in a mobile device, the system comprising: a processing unit; a computer-readable medium having encoded thereon, computer-readable instructions that, when executed by the processing unit, causes the system to perform operations comprising: configuring a default device posture based on an initial tilt angle that is retrieved from a hardware sensor of the mobile device; rendering a first user interface layer on a display of the mobile device; enabling an interactable element within the first user interface layer; receiving, by the hardware sensor, a first tilt input comprising a first modified tilt angle of the mobile device, wherein: a difference between the first modified tilt angle and the initial tilt angle represents a first deviation from the default device posture; and the first deviation from the default device posture does not satisfy a threshold deviation; in response the first deviation from the default device posture not satisfying the threshold deviation, maintaining the stack of at least two user interface layers, wherein the interactable element within the first user interface layer remains enabled and an interactable element within the second user interface layer is disabled; receiving, by the hardware sensor, a second tilt input comprising a second modified tilt angle of the mobile device, wherein: a difference between the second modified tilt angle and the initial tilt angle represents a second deviation from the default device posture; and the second deviation from the default device posture satisfies the threshold deviation; in response to the second deviation from the default device posture satisfying the threshold deviation, transitioning from the first user interface layer to the second user interface layer by: removing the rendering of the first user interface layer; disabling the interactable element of the first user interface layer; rendering the second user interface layer; and enabling the interactable element within the second user interface layer.

Example Clause J, the system of Example Clause I, wherein the configuring is implemented in response to an activation signal.

Example Clause K, the system of Example Clause J, wherein the activation signal is a manual input or the activation signal is automatically generated by an operating system of the mobile device.

Example Clause L, the system of any one of Example Clause I through K, wherein: the first user interface layer and the second user interface layer belong to a same software application; the first user interface layer includes a primary functionality of the software application; the second user interface layer includes a secondary functionality of the software application; and the first user interface layer is configured as a default user interface layer.

Example Clause M, the system of any one of Example Clause I through L, wherein: the first user interface layer and the second user interface layer are rendered as a stack; and a transparency of the first user interface layer and the second user interface layer is configured based on a deviation from the default device posture.

Example Clause N, the system of any one of Example Clause I through M, wherein: the first tilt input and the second tilt input are vertical tilt inputs; and the first modified tilt angle and the second modified tilt angle are received by the hardware sensor with respect to a vertical axis.

Example Clause O, the system of any one of Example Clause I through M, wherein: the first tilt input and the second tilt input are horizontal tilt inputs; and the first modified tilt angle and the second modified tilt angle are received by the hardware sensor with respect to a horizontal axis.

Example Clause P, the system of any one of Example Clause I through O, wherein the operations further comprise reconfiguring the default device posture based on an updated tilt angle in response to receiving a device posture reset input.

Example Clause Q, a computer-readable storage medium having encoded thereon, computer-readable instructions that, when executed by a processing unit, causes a system to perform operations comprising: configuring a default device posture based on an initial tilt angle that is retrieved from a hardware sensor of the mobile device; rendering a first user interface layer on a display of the mobile device; enabling an interactable element within the first user interface layer; receiving, by the hardware sensor, a first tilt input comprising a first modified tilt angle of the mobile device, wherein: a difference between the first modified tilt angle and the initial tilt angle represents a first deviation from the default device posture; and the first deviation from the default device posture does not satisfy a threshold deviation; in response the first deviation from the default device posture not satisfying the threshold deviation, maintaining the stack of at least two user interface layers, wherein the interactable element within the first user interface layer remains enabled and an interactable element within the second user interface layer is disabled; receiving, by the hardware sensor, a second tilt input comprising a second modified tilt angle of the mobile device, wherein: a difference between the second modified tilt angle and the initial tilt angle represents a second deviation from the default device posture; and the second deviation from the default device posture satisfies the threshold deviation; in response to the second deviation from the default device posture satisfying the threshold deviation, transitioning from the first user interface layer to the second user interface layer by: removing the rendering of the first user interface layer; disabling the interactable element of the first user interface layer; rendering the second user interface layer; and enabling the interactable element within the second user interface layer.

Example Clause R, the computer-readable storage medium of Example Clause Q, wherein: the first tilt input and the second tilt input are vertical tilt inputs; and the first modified tilt angle and the second modified tilt angle are received by the hardware sensor with respect to a vertical axis.

Example Clause S, the computer-readable storage medium of Example Clause Q, wherein: the first tilt input and the second tilt input are horizontal tilt inputs; and the first modified tilt angle and the second modified tilt angle are received by the hardware sensor with respect to a horizontal axis.

Example Clause T, the computer-readable storage medium of any one of Example Clause Q through S, wherein the operations further comprise reconfiguring the default device posture based on an updated tilt angle in response to receiving a device posture reset input.

Conditional language such as, among others, “can,” “could,” “might” or “may,” unless specifically stated otherwise, are understood within the context to present that certain examples include, while other examples do not include, certain features, elements, and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for tilt navigation of a stack of at least two user interface layers in a mobile device, the method comprising:
configuring a default device posture based on an initial tilt angle that is retrieved from a hardware sensor of the mobile device;
rendering a first user interface layer in the stack on a display of the mobile device;
enabling an interactable element within the first user interface layer in the stack;
receiving, by the hardware sensor, a first tilt input comprising a first modified tilt angle of the mobile device, wherein:
a difference between the first modified tilt angle and the initial tilt angle represents a first deviation from the default device posture; and
the first deviation from the default device posture does not satisfy a threshold deviation;
in response to the first deviation from the default device posture not satisfying the threshold deviation, applying a transparency effect to the first user interface layer in the stack to reveal, on the display of the mobile device, a preview of a second user interface layer in the stack beneath the first user interface layer in the stack, wherein:
an interactable element within the second user interface layer in the stack is visible through the first user interface layer in the stack; and
the interactable element within the second user interface layer in the stack is disabled in the preview of the second user interface layer in the stack beneath the first user interface layer in the stack;
receiving, by the hardware sensor, a second tilt input comprising a second modified tilt angle of the mobile device, wherein:
a difference between the second modified tilt angle and the initial tilt angle represents a second deviation from the default device posture; and
the second deviation from the default device posture satisfies the threshold deviation;
in response to the second deviation from the default device posture satisfying the threshold deviation, transitioning from the first user interface layer in the stack to the second user interface layer in the stack by:
removing the first user interface layer in the stack from the display of the mobile device; and
enabling the interactable element within the second user interface layer in the stack.

2. The method of claim 1, wherein the configuring is implemented in response to an activation signal.

3. The method of claim 2, wherein the activation signal is a manual input or the activation signal is automatically generated by an operating system of the mobile device.

4. The method of claim 1, wherein:
the first user interface layer in the stack and the second user interface layer in the stack belong to a same software application;
the first user interface layer in the stack includes a primary functionality of the software application;
the second user interface layer in the stack includes a secondary functionality of the software application; and
the first user interface layer in the stack is configured as a default user interface layer.

5. The method of claim 1, wherein an intensity of the transparency effect varies continuously in proportion to the first modified tilt angle.

6. The method of claim 1, wherein:
the first tilt input and the second tilt input are vertical tilt inputs; and
the first modified tilt angle and the second modified tilt angle are received by the hardware sensor with respect to a vertical axis.

7. The method of claim 1, wherein:
the first tilt input and the second tilt input are horizontal tilt inputs; and
the first modified tilt angle and the second modified tilt angle are received by the hardware sensor with respect to a horizontal axis.

8. The method of claim 1, further comprising reconfiguring the default device posture based on an updated tilt angle in response to receiving a device posture reset input.

9. A mobile device for tilt navigation of a stack of at least two user interface layers, the mobile device comprising:
a processing unit;
a computer-readable medium having encoded thereon, computer-readable instructions that, when executed by the processing unit, causes the mobile device to perform operations comprising:
configuring a default device posture based on an initial tilt angle that is retrieved from a hardware sensor of the mobile device;
rendering a first user interface layer in the stack on a display of the mobile device;
enabling an interactable element within the first user interface layer in the stack;
receiving, by the hardware sensor, a first tilt input comprising a first modified tilt angle of the mobile device, wherein:
a difference between the first modified tilt angle and the initial tilt angle represents a first deviation from the default device posture; and
the first deviation from the default device posture does not satisfy a threshold deviation;
response to the first deviation from the default device posture not satisfying the threshold deviation, applying a transparency effect to the first user interface layer in the stack to reveal, on the display of the mobile device, a preview of a second user interface layer in the stack beneath the first user interface layer in the stack, wherein:
the interactable element within the first user interface layer in the stack remains enabled; an interactable element within the second user interface layer in the stack is visible through the first user interface layer in the stack; and
the interactable element within the second user interface layer in the stack is disabled in the preview of the second user interface layer in the stack;
receiving, by the hardware sensor, a second tilt input comprising a second modified tilt angle of the mobile device, wherein:
a difference between the second modified tilt angle and the initial tilt angle represents a second deviation from the default device posture; and
the second deviation from the default device posture satisfies the threshold deviation;
in response to the second deviation from the default device posture satisfying the threshold deviation, transitioning from the first user interface layer in the stack to the second user interface layer in the stack by:
removing the first user interface layer in the stack from the display of the mobile device; and
enabling the interactable element within the second user interface layer in the stack.

10. The mobile device of claim 9, wherein the configuring is implemented in response to an activation signal.

11. The mobile device of claim 10, wherein the activation signal is a manual input or the activation signal is automatically generated by an operating system of the mobile device.

12. The mobile device of claim 9, wherein:
the first user interface layer in the stack and the second user interface layer in the stack belong to a same software application;
the first user interface layer in the stack includes a primary functionality of the software application;
the second user interface layer in the stack_includes a secondary functionality of the software application; and
the first user interface layer in the stack is configured as a default user interface layer.

13. The mobile device of claim 9, wherein; an intensity of the transparency effect varies continuously in proportion to the first modified tilt angle.

14. The mobile device of claim 9, wherein:
the first tilt input and the second tilt input are vertical tilt inputs; and
the first modified tilt angle and the second modified tilt angle are received by the hardware sensor with respect to a vertical axis.

15. The mobile device of claim 9, wherein:
the first tilt input and the second tilt input are horizontal tilt inputs; and
the first modified tilt angle and the second modified tilt angle are received by the hardware sensor with respect to a horizontal axis.

16. The mobile device of claim 9, wherein the operations further comprise reconfiguring the default device posture based on an updated tilt angle in response to receiving a device posture reset input.

17. A computer-readable storage medium having encoded thereon, computer-readable instructions that, when executed by a processing unit, cause a mobile device to perform operations comprising:
configuring a default device posture based on an initial tilt angle that is retrieved from a hardware sensor of the mobile device;
rendering a first user interface layer in a stack of at least two user interface layers on a display of the mobile device;
enabling an interactable element within the first user interface layer in the stack;
receiving, by the hardware sensor, a first tilt input comprising a first modified tilt angle of the mobile device, wherein:
a difference between the first modified tilt angle and the initial tilt angle represents a first deviation from the default device posture; and
the first deviation from the default device posture does not satisfy a threshold deviation;
in response to the first deviation from the default device posture not satisfying the threshold deviation, applying a transparency effect to the first user interface layer in the stack to reveal, on the display of the mobile device, a preview of of a second user interface layer in the stack beneath the first user interface layer in the stack, wherein:
the interactable element within the first user interface layer in the stack remains enabled;
an interactable element within the second user interface layer in the stack is visible through the first user interface layer in the stack; and
the interactable element within the second user interface layer in the stack is disabled in the preview of the second user interface layer in the stack beneath the first user interface layer in the stack;
receiving, by the hardware sensor, a second tilt input comprising a second modified tilt angle of the mobile device, wherein:
a difference between the second modified tilt angle and the initial tilt angle represents a second deviation from the default device posture; and
the second deviation from the default device posture satisfies the threshold deviation;
in response to the second deviation from the default device posture satisfying the threshold deviation, transitioning from the first user interface layer in the stack to the second user interface layer in the stack by:
removing the first user interface layer in the stack from the display of the mobile device; and
enabling the interactable element within the second user interface layer in the stack.

18. The computer-readable storage medium of claim 17, wherein:
the first tilt input and the second tilt input are vertical tilt inputs; and
the first modified tilt angle and the second modified tilt angle are received by the hardware sensor with respect to a vertical axis.

19. The computer-readable storage medium of claim 17, wherein:
the first tilt input and the second tilt input are horizontal tilt inputs; and
the first modified tilt angle and the second modified tilt angle are received by the hardware sensor with respect to a horizontal axis.

20. (canceled)

21. The method of claim 1, further comprising disabling the tilt navigation after transitioning from the first user interface layer in the stack to the second user interface layer in the stack based on user enablement of a user interface lock.
